(19) United States
(12) Patent Application Publication
(10) Pub. No.: US 2026/0098783 A1
(43) Pub. Date: Apr. 9, 2026

(54) HYBRID HYDRAULIC-ELECTRODYNAMIC VIBRATION TEST SYSTEM

(71) Applicant: Crystal Instruments Corporation, Santa Clara, CA (US)

(72) Inventor: James Q. Zhuge, Palo Alto, CA (US)

(73) Assignee: Crystal Instruments Corporation, Santa Clara, CA (US)

(21) Appl. No.: 18/906,125

(22) Filed: Oct. 3, 2024

(51) Int. Cl. G01M 7/02; B06B 1/02; B06B 1/04; B06B 1/18

(52) U.S. Cl. CPC G01M 7/022; B06B 1/0284; B06B 1/045; B06B 1/183; G01M 7/025; B06B 2201/40

(57) ABSTRACT

A hybrid shaker system comprises two subsystems: a hydraulic shaker that generates vibrational movement mainly in a low frequency range, and an electrodynamic (ED) shaker that generates vibrations mainly in a high frequency range, with both contributing within a transitional intermediate frequency range. The shaker subsystems are connected in series so that cylinder piston rods of the hydraulic system drive the ED shaker housing, which in turn vibrates a unit-under-test (UUT). A single integrated vibration controller controls both the servo system of the hydraulic system and the power amplifier of the ED shaker using comparison of a target vibration profile with sensor feedback from the ED shaker housing and UUT. Vibrational movement of the UUT over a complete frequency range up to a few thousand kilohertz can be covered, while providing very large displacements up to 25 centimeters during the same test.

### TECHNICAL FIELD

The present invention relates apparatus and methods for vibration and/or shock testing of structures wherein a unit under test is mounted onto a test stand or table, subjected to one or more vibrations or shocks of controlled profile, and that unit's response is measured. Vibration test systems that meet minimum requirements of both displacement and frequency range are of particular interest.

### BACKGROUND ART

In environmental testing, the goal of vibration testing equipment is to simulate real-life vibrations, such as the movement of an automobile, the motion of a train, a rocket launch, or other vibration scenario. This allows for the reliability and performance of the Unit Under Test (UUT) to be assessed and verified in a controlled lab environment. The vibration signature being simulated can take various forms, including random, sine, shock, transient, random-on-random, sine-on-random, and others. These testing types are governed by various standards. Vibration testing systems must meet certain requirements, such as maximum displacement, maximum velocity, maximum acceleration, and frequency range.

One of the major limitations of these testing systems is the contradictory relationship between frequency range and displacement. Typically, testing equipment that offers very large displacement cannot cover a very high frequency range, while a system capable of high-frequency testing cannot provide large displacement. For example, a vibration shaker that operates up to 2.5 kHz is usually an electrodynamic shaker, which typically cannot achieve more than 7.5 cm (3 inches) of displacement. Conversely, a vibration shaker that can offer 25 cm (10 inches) of displacement is usually a hydraulic shaker, which is limited to a maximum frequency of around 300 Hz. However, real-life vibrations often involve both displacements greater than 25 cm and frequencies up to 2.5 kHz or more. In a single swept sine test, the user may ask for a displacement as large as 25 cm at 0.1 Hz while it sweeps up to 2000 Hz with a 1 g peak acceleration. In another typical test using random signal, the test may ask for a wide band spectrum covering a specific spectral shape between 0.2 Hz to 3 kHz while as much as 50 cm (20 inches) of displacement is required. So far, no vender has been able to provide testing equipment that can achieve target specifications meeting such real-life simulation requirements.

Without any equipment that can achieve these requirements, the user is forced to move the UUT between multiple types of vibration testing equipment to complete separate tests. This is both time-consuming and expensive. Moreover, dividing the tests into sub-tests to meet the requirements of both large displacement and high-frequency vibration does not yield the same results as performing a test in a single cycle. In other words, there is no ideal technical solution in the industry today that can generate vibrations that encompass both large displacements and a wide frequency range in a complete test cycle.

Toyota Motor Corp. has a vibration device, described in Japanese Patent Application Publication JP2013-24733A (published Feb. 4, 2013) and Japanese Patent JP5627544B2 (granted Nov. 19, 2014), that combines both a hydraulic vibration part and an electrodynamic vibration part, each providing a vibration force in a specified predetermined ratio. It is mainly used to test the strain and stress that a tested article can withstand. So, the purpose is to generate a required force to be applied to the tested article with certain criteria. In their design (shown here in FIG. 1), the cylinder (33) of the hydraulic actuator (30) and the armature (53a) of the electrodynamic exciter (50) are connected in parallel to the same plate (20). The respective forces from the hydraulic unit and the electrodynamic unit are applied additively to the plate and thus to the article W being tested. FIG. 2 represents a simplified mechanical model, where M is the mass of the plate and article, X the displacement of M, K1 and K2 stand for stiffness, C1 and C2 the damping, and F1 and F2 the respective forces of excitation. During a test, the housings of both the hydraulic unit and electrodynamic unit are fixed to the ground and do not move. The respective housings are separate except that a certain portion of the ED housing needs to be mounted to the hydraulic cylinders. Because of the parallel structure, the largest displacement the hydraulic unit can provide is limited by the height of the drive coil (53). The hydraulic cylinder cannot move beyond the height of the drive coil, else the drive coil would be pulled out. Additionally, the electrodynamic unit is limited in its maximum frequency (to about 1000 Hz), because even when it is the only active vibration part, the hydraulic components are still connected to the same testing plate (20) with their high damping effect upon the motion generated.

### SUMMARY DISCLOSURE

The present invention is a hybrid shaker system that comprises two sub-shaker systems: (1) a hydraulic shaker that generates movement mainly in low frequency range and (2) an electrodynamic (ED) shaker that generates the movement in the high frequency range. The two sub-shaker systems are connected in series so that the cylinders of hydraulic system drive the ED shaker housing. A single integrated vibration controller controls both the servo system of hydraulic system and the power amplifier of the ED shaker, so that movement of a unit-under-test (UUT) covers the complete frequency range up to a few thousand kilohertz, while it can also provide very large displacements (e.g., up to 25 cm) during the same test.

The hybrid vibration testing system comprises the hydraulic shaker (HS) subsystem, the electrodynamic (ED) shaker subsystem, and a vibration control system. The HS subsystem includes at least hydraulic pump, cylinder and servo valve elements. The ED shaker subsystem includes at least a power amplifier, a shaker body coupled with its base, a shaker armature, and a shaker table configured to support a unit-under-test (UUT). The HS and ED shaker subsystems are mechanically coupled in series such that the base of the ED shaker subsystem is fixed to the cylinder of the HS subsystem. Further, for stability, the mechanical coupling takes account of the center of gravity of the ED shaker subsystem. The vibration control system, with one or more processors, generates a first drive signal to be sent to the power amplifier of the ED shaker subsystem and a second drive signal to be sent to the servo valve of the HS subsystem, wherein the data streams of those two drive signals are computed by a control algorithm in a feedback control loop. For this purpose, first real-time input signals from sensors configured to measure movement of the base of the ED shaker subsystem and second real-time input signals from sensors configured to measure vibrations on the UUT are received by the vibration control system and compared to target vibration values in the frequency domain. Drive signals are allocated to the respective hydraulic and electrodynamic shaker subsystems according to the frequency characteristics of the two sub-systems, where HS subsystem vibration movement contribution tends to be in a low-frequency band, the ED shaker subsystem vibration movement contribution tends to be in a high-frequency band, and there is an intermediate transitional frequency band where both shakers contribute to the vibration in relative proportions dependent upon the frequence response functions of the two sub-systems and testing configuration.

### BRIEF DESCRIPTION OF THE DRAWINGS

FIG. 1 is a side sectional view of a prior art hybrid testing system with both hydraulic and electrodynamic units applying force in parallel to a plate on which an article to be tested is mounted.

FIG. 2 is a schematic mechanical model of the prior art system of FIG. 1.

FIG. 3 is a side elevational schematic view of one possible hybrid testing system with in-series application of vibrations from hydraulic and electrodynamic subsystems. The placement of the electrodynamic subsystem on top of the hydraulic shake table tends to be unstable and could tilt during a test.

FIG. 4 is a side elevational schematic view of a preferred hybrid testing system in accord with the present invention with in-series application of vibrations from hydraulic and electrodynamic subsystems. The use of a multi-cylinder hydraulic system and mounting of the electrodynamic subsystem's shaker body to the hydraulic table with a lowered center of gravity is a more stable configuration.

FIG. 5 is a schematic mechanical model of the hybrid system of FIG. 4.

FIG. 6 is a side elevational schematic view of an alternative hybrid testing system in accord with the present invention providing horizontal shaking via hydraulic and electrodynamically actuated slide tables.

FIG. 7 is a schematic representation of the basic components of an electrodynamic subsystem that can be used in a hybrid testing system of the present invention. The electrodynamic shaker unit 85 would be mounted to a hydraulic unit as in a configuration like that of FIG. 4.

FIG. 8 is a side sectional view of core elements of the electrodynamic shaker unit of FIG. 7.

FIG. 9 is a schematic representation of the basic components of a hydraulic subsystem that can be sed in a hybrid testing system of the present invention. An electrodynamic shaker unit would be mechanically mounted to the actuator 104 of the hydraulic shaker unit 100 as in a configuration like that of FIG. 4.

FIGS. 10 and 11 are perspective views of the core mechanical elements (including actuator cylinders) of the example hydraulic shaker in FIG. 9.

FIG. 12 is an overall schematic diagram of the drive and vibration control signals connection between hybrid shaker mechanical elements 131, 135, and 139 and a controller 130 in accord with the present invention.

FIG. 13 is a close-up schematic of basic elements of the controller 103 in FIG. 12 for generating controlled drive signals using vibration signal inputs to match a target profile.

FIG. 14 is a schematic diagram of a complete vibration control setup for a hybrid vibration test system in accord with the present invention.

FIG. 15 is a schematic diagram illustrating essential features for a control process in a swept sine vibration test.

FIG. 16 is a graph illustrating optional use of tracking filters to reduce the noise and harmonic signals above and below the sine drive frequency in a control process as in FIG. 15.

FIG. 17 is a graph in the frequency domain of a user-defined target profile for use in a control process as in FIG. 15.

FIG. 18 is a graph in the frequency domain illustrating the controller's relative drive allocation to the hydraulic (HS) and electrodynamic (ED) subsystems for low, intermediate, and high frequency bands. During a sine sweep through the transition band, the vibration comes from the motion of both ED and HS.

FIG. 19 is a block schematic showing that data streams for both hydraulic and electrodynamic drive signals are generated by the controller using the same control feedback loop, so that the respective drive signals in the two paths are synchronized and the phase shift of each path are calibrated to each other.

FIG. 20 is a graph in the frequency domain illustrating the controller's relative drive allocation to the HS and ED subsystems for random vibration components in low, intermediate, and high frequency bands, illustrating the same solution of FIG. 18 is employed also for random tests as in the swept sine test.

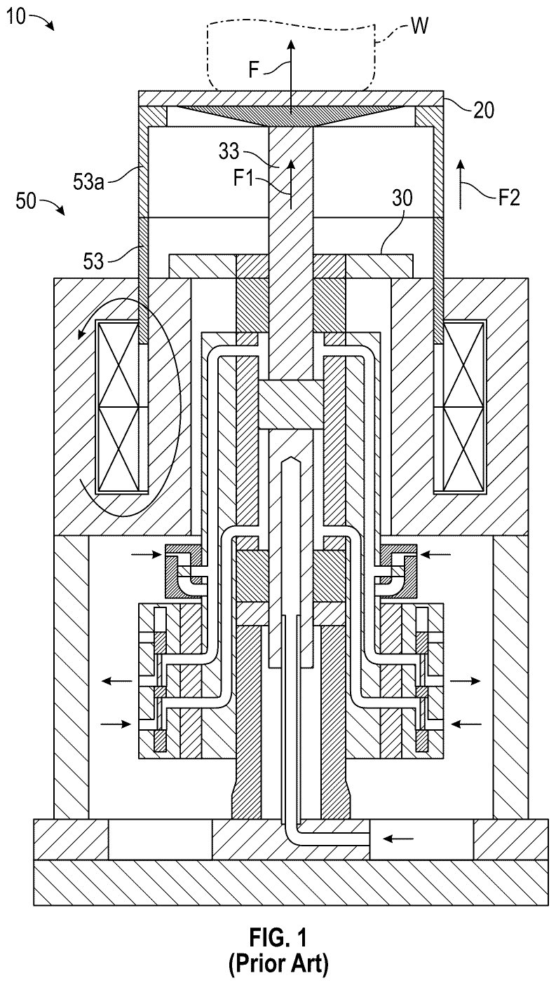

### DETAILED DESCRIPTION

In the present invention, the hydraulic unit and electrodynamic unit are connected in series. The electrodynamic shaker's housing is fixed to the top of cylinder(s). During the test, the housing of ED shaker moves together with the piston rod in the cylinder of the hydraulic shaker.

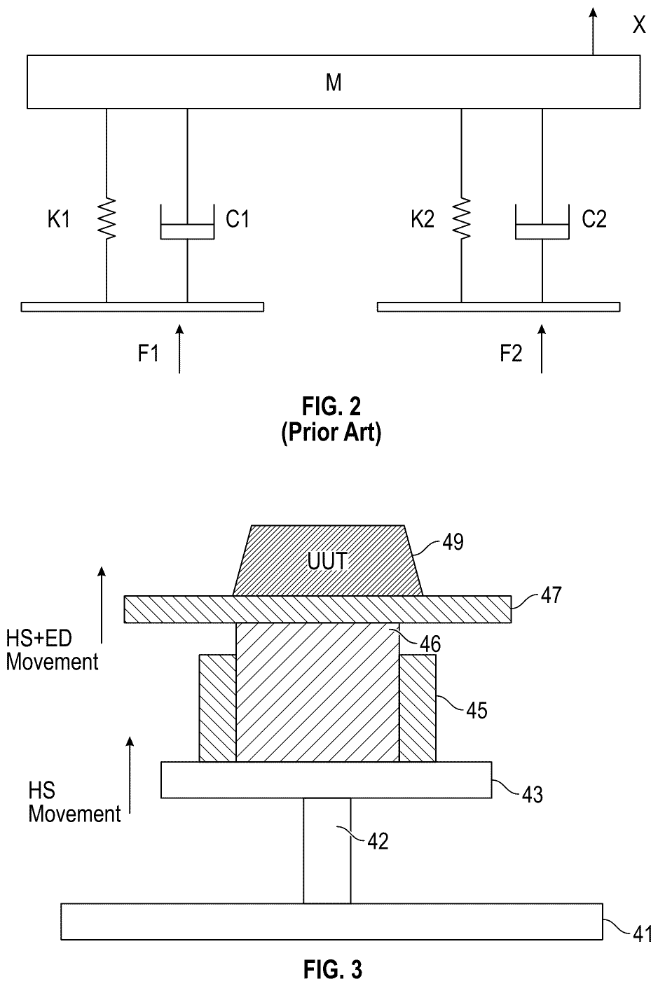

In theory, a hybrid vibration testing system might simply be configured as in FIG. 3, so that an ED shaker body 45 is stacked on top of the HS shaker table 43. In this diagram, it is shown that an ED shaker with typical cylindrical shape is placed on top of table 43 of the hydraulic shaker system. The hydraulic cylinder piston rod 42 is mounted to base 41 of the hydraulic system and applies HS vibrational movement to table 43. Armature 46 of the ED shaker body 45 adds an ED vibrational movement to table 47 so that the final movement of the unit-under-test (UUT) 49 will be governed by the total contribution from both ED and HS systems.

While this design of mechanical coupling between two sub-systems can indeed generate the desired vibration vertically, the structure tends to be instable. That is, it can be easily tilted to the side. In engineering terms, the potential risk of tilting can be assessed through the calculation of an overturning moment. Any mechanical design should pass the design criteria for overturning moment given certain conditions such as the weight of the UUT and the required testing parameters.

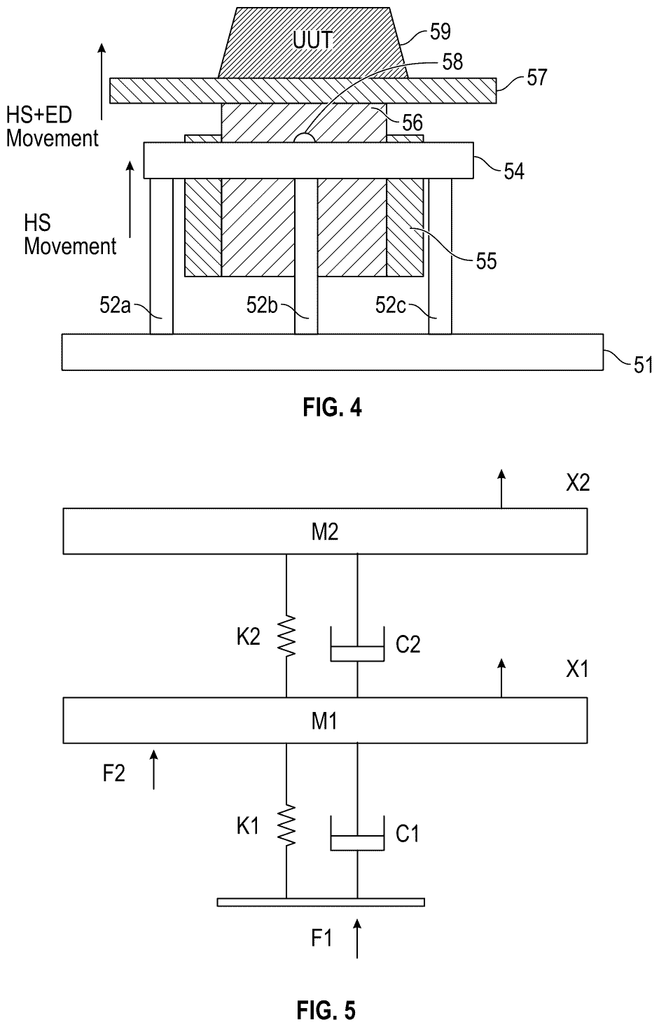

To provide a hybrid system that is inherently more stable, a preferred architectural structure is provided as in FIG. 4, which uses three actuators 52a, 52b, and 52c, for the hydraulic systems, while the center of gravity 58 of ED shaker and its UUT 59 is positioned at the same level of HS table 54. Otherwise, the hydraulic cylinders 52a-52c are mounted to base 51 of the hydraulic shaker subsystem and apply HS vibrational movement to table 54. The armature 56 in the ED shaker housing 55 adds an ED vibrational movement to table 57 so that the final movement of UUT 59 will be governed by the total contribution from both ED and HS systems. Unlike the design in FIG. 3, this improved configuration, with its lower placement of the ED shaker housing 55, can maintain the stability of the whole architecture during the vibration testing.

As seen in FIG. 5, the mechanical model of the FIG. 4 configuration (as also in the less stable FIG. 3 configuration) is one of a series connection between the hydraulic and electrodynamic subsystems. M1 represents the mass of the hydraulic shaker plate, X1 the displacement of M1, M2 is the combined mass of the electrodynamic shaker plate and the unit under test, X2 the displacement of M2, K1 and K2 stand for stiffness, C1 and C2 the damping, and F1 and F2 the respective forces of excitation. Because ED shaker housing 55 is still mounted to the HS table 54 that is on top of hydraulic cylinders 52a-52c in our invention, there is no restriction that the ED unit and HS unit must stay close in the one housing. In fact, their housings are separated except that certain portion of ED housing needs to be mounted to the hydraulic cylinders via table 54. The large displacement possible with the piston rods of the hydraulic cylinders is not hindered by the ED shaker, nor is the high frequency contribution of the ED shaker hindered by any damping from the HS system. Each subsystem contributes additively to the overall vibration motion without hindrance.

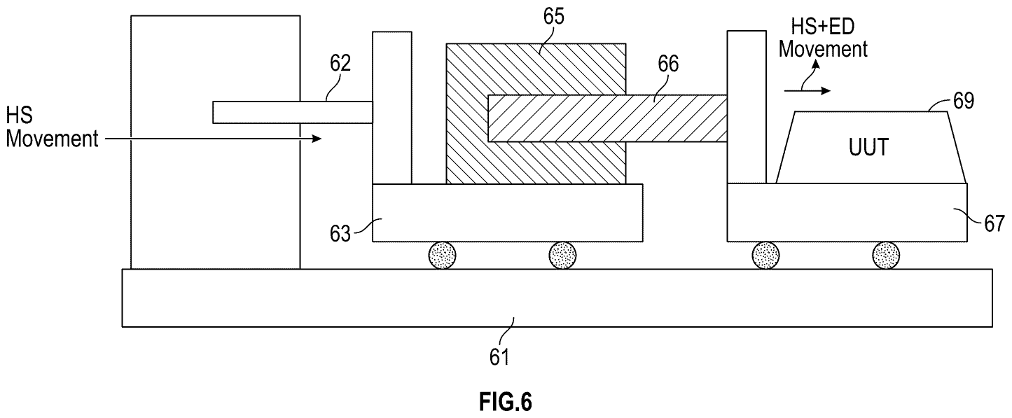

Likewise, a hybrid system can be constructed as in FIG. 6, so that the movement is horizontal. The piston rod of the hydraulic cylinder 62 applies horizontal vibration to a first slip table 63. The ED shaker housing is mounted on the first slip table 63. Two stages of slip tables 63 and 67 will be used in such a way that the weight of ED shaker (housing 65, armature and extension 66) and UUT 69 falls to each of slip tables 63 and 67, where the UUT 69 sits upon the ED slip table 67 and receives the combined vibrational movement of both shakers.

### Electro-Dynamic (ED) Shaker Sub-System:

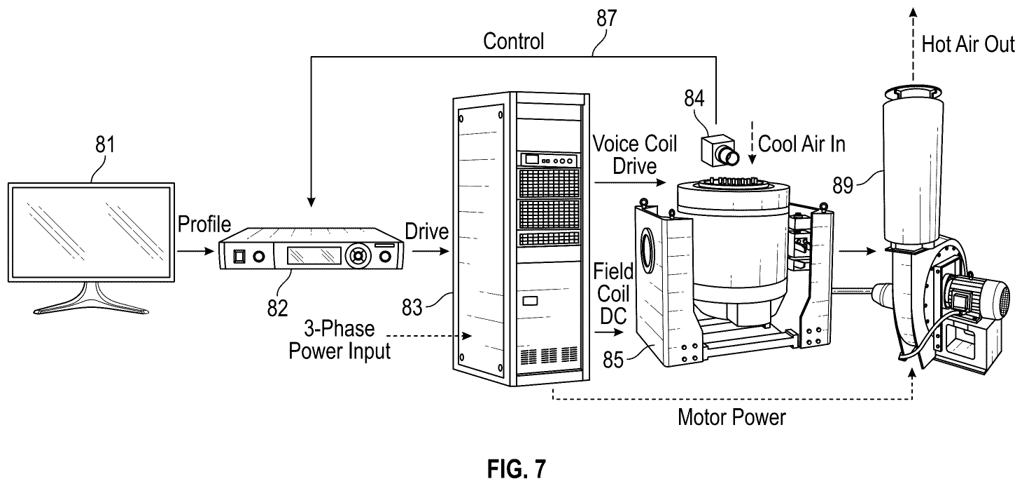

At a minimum, an ED sub-system, as in FIG. 7, will include a vibration controller 82, a shaker 85, a power amplifier 83 and a blower 89. The housing of shaker 85 will be attached to a hydraulic shake table as in the configuration of FIG. 4. Controller 82 is the “brain” of the system. It uses accelerometer 84 on the shaker table 86 (occasionally on the tested specimen) to measure the vibratory motion during a random, swept sine or shock test. The required details (profile) of the test can be loaded into controller 82 from a personal computer (PC) 81. The controller continuously compares the measured Control signal 87 to a desired reference Profile specified for the test and computes the necessary Drive signal for the shaker to force the Control to match the Profile. The controller also can perform a myriad of analytical support functions including pre-test feasibility analysis and protective limit measurements during the test.

The amplifier 83 is the closed loop's “power broker and operational cop”. Its fundamental mission is to power amplify the low voltage drive signal 88 from the controller and apply a high-current version of it to the shaker's voice coil. But it also provides a strong constant DC current to the shaker's field coils and 3-phase electrical power to the cooling blower.

The shaker 85 provides the system's “brawn”, the electromechanical muscle needed to provide sufficient force to move the device under test (DUT) at the vertical acceleration level required. To do this, it must have sufficient force, stroke, and acceleration capacity. It must also have a frequency bandwidth that meets or exceeds the test's specification. Further, it needs the capacity to statically support the device under test and must have a sufficiently large load table 86 to properly attach and support the DUT. In some instances, shaking the DUT horizontally is essential. In this case, the shaker is tipped to the horizontal and used to drive a slip table through a driver bar. The slip table and shaker may be purchased as separate free-standing components, or in a common mono-base for easier conversion from horizontal to vertical operation.

The blower 89 cools the shaker 85. It draws cool laboratory air in through a filter surrounding the load table. The air flows down over the voice coil and the field coils, past the iron magnetic pole pieces and into an air chamber that is evacuated by a flexible hose leading to the blower. The heated air exits the blower through a silencer. For small systems, the blower may be located in the shaker space. To avoid recirculating the hot air, the blower's outlet may be vented to the outdoors. For large systems, the blower itself is located outside reducing both noise and recirculated heat.

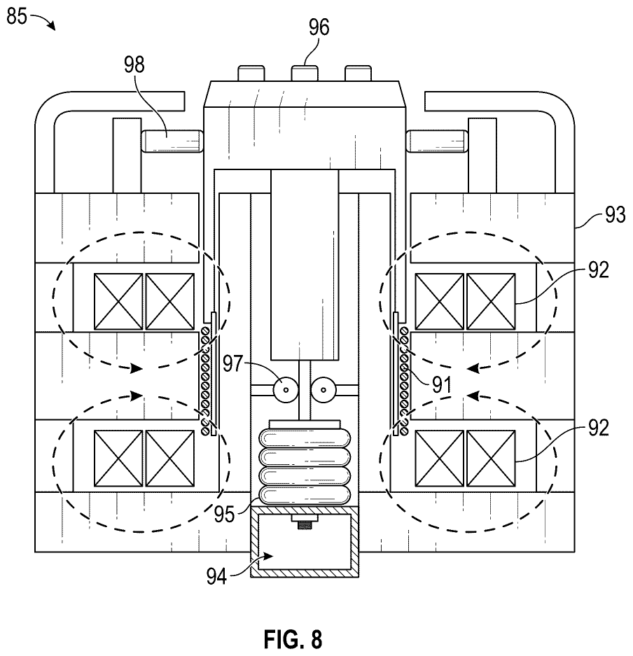

As seen in FIG. 8, electrodynamic (ED) shakers 85 operate on the same basic principles as loudspeakers, using electromagnetic forces to generate motion. The core mechanism involves passing an electric current through a wire (voice coil 91) that sits within a magnetic field (created by a field coil 92). This interaction produces a force perpendicular to both the wire and the magnetic flux, causing the wire to move. The strength of this force is directly proportional to the current, the strength of the magnetic field, and the length of the wire within that field.

In an ED shaker, the voice coil 91 is wound around a cylindrical body that forms part of the shaker's armature 96. The armature 96 is elastically suspended (e.g., air chamber 94, air spring 95, lower suspension 97, upper suspension 98) within a radial magnetic field, allowing it to move axially (up and down) relative to the shaker body 93. This movement is restricted to a certain range, known as the displacement stroke, which defines the maximum distance the armature 96 can travel. The axial force exerted on the armature is proportional to the electrical current applied, enabling precise control over the shaker's motion.

The suspension system plays a crucial role in guiding the armature's movement. It keeps coil 91 concentric within the magnetic field created by field coil 92, ensuring that the armature 96 moves smoothly and remains within its designated stroke range. This setup is critical for maintaining the accuracy and consistency of the shaker's performance, as it prevents the armature from deviating from its path or overextending beyond its designed limits.

Smaller ED shakers typically use permanent magnets to create the magnetic field and employ simple elastic flexures for the suspension system. These shakers are robust and capable of generating oscillating forces, which are transmitted to the test object through a thin rod, known as a drive quill or stinger. In some cases, if the test object is light enough, it can be attached directly to the shaker armature, allowing for whole-body vibration testing. However, this configuration can reduce the available vibration stroke as the suspension system compensates for the additional static weight of the test object.

As shakers increase in size and capacity, the use of permanent magnets becomes impractical due to the stronger magnetic fields required. Instead, these larger shakers utilize electromagnetic coils 92 energized by a fixed DC current to generate the magnetic field. The armature's voice coil 91, positioned within this magnetic field, is driven by a variable current that induces vibratory motion. To minimize magnetic leakage and protect the device under test (DUT) and control instruments, the magnetic field is carefully focused using a pair of axial field coils 92, which position the flux field lower within the shaker's iron body 93.

### Hydraulic Shaker (HS) Sub-System:

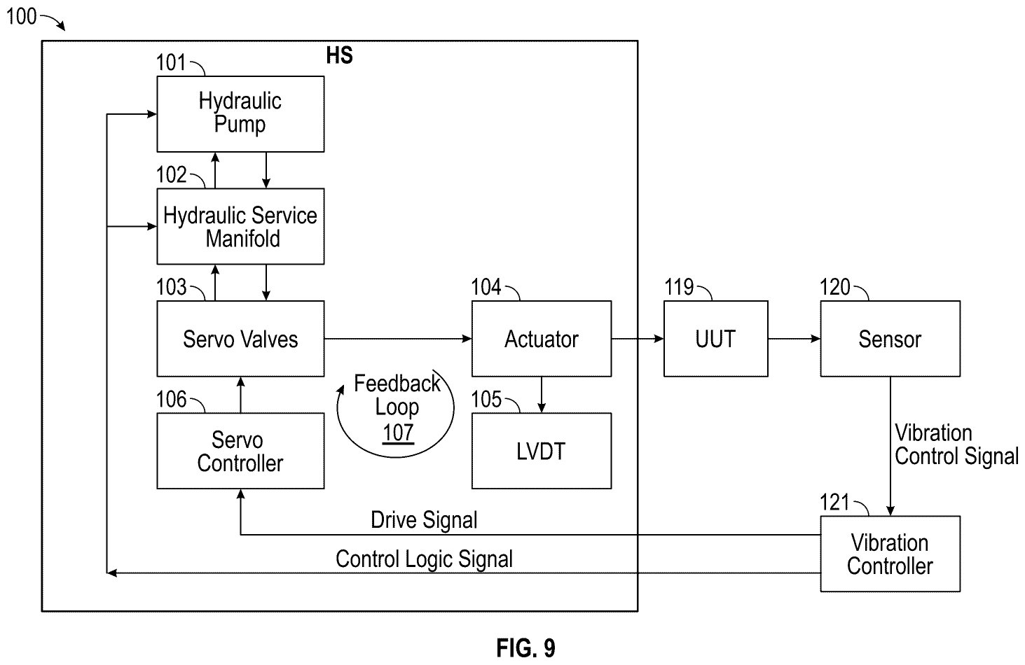

A hydraulic shaker 100, as seen in FIG. 9, is a sophisticated system designed to replicate vibration activities for testing the resilience of structures using hydraulic power. The system relies on the precise coordination of various components, each playing a crucial role in generating and controlling the shaking motion. That shaking motion will then be transferred from the hydraulic actuators and associated shake table to the electrodynamic shaker body 119 as in the configuration of FIG. 4. The basic components of a hydraulic shaker 100 are as follows:
1. Hydraulic Power System (Pump and HSM): The process begins with the Hydraulic Power Unit (HPU) 101, which acts as the heart of the system by generating the necessary hydraulic pressure. The pump within the HPU continuously delivers a high-pressure flow of hydraulic fluid to the system. This fluid is essential for driving the movement of the actuators 104 that, in turn, move the simulator platform 119, here attached to the electrodynamic shaker subsystem. The hydraulic fluid is channeled through the Hydraulic Service Manifold (HSM) 102, which serves as a distribution center. The HSM 102 not only directs the fluid to various actuator channels but also contains accumulators that manage fluid pressure, ensuring steady operation even during peak flow demands. This regulated flow of hydraulic fluid is critical for maintaining consistent performance of the shaker system.
2. Servo-Control System and Servo valve: The servo-control system is the brain of the hydraulic shaker, coordinating the actions of the entire setup. At the core of this system is the servo valve 103, which functions as the final control element in the hydraulic circuit. The servo valve 103 receives high-pressure hydraulic fluid from the HPU 101 and precisely directs it to either side of the actuator cylinder (s) 104 based on the control signals it receives from servo controller 106. By modulating the flow and pressure of the fluid entering the actuator, the servo valve 103 controls the movement of the actuator's piston rod. This precise control allows the simulator platform 119 to move in the desired direction and with the required force, mimicking the desired vibration conditions (such as that from an earthquake).
3. Linear Actuator and Cylinder: The actuator 104 is a key component that converts the hydraulic energy into mechanical motion. Inside the actuator, the cylinder houses a piston that moves back and forth in response to the hydraulic fluid pressure controlled by the servo valve 103. The movement of the piston rod, which extends from the cylinder, directly translates to the motion of the simulator platform 119. The force exerted by the actuator 104 is determined by the pressure of the hydraulic fluid and the surface area of the piston. The actuator's cylinder is designed to handle the high-pressure fluid and to provide smooth, controlled motion, which is essential for accurate simulation of seismic forces.
4. Feedback from Sensors and Control Loop: The accuracy and reliability of the hydraulic shaker system are maintained through a sophisticated feedback loop 107. The system relies on a variety of sensors to continuously monitor the movement, and forces involved. A key sensor is the Linear Variable Differential Transformer (LVDT) 105 located inside the actuator 104, which measures the precise displacement of the piston rod. Additionally, load cells attached to the actuator measure the force being exerted. If there is any deviation, the servo-controller adjusts the servo valve position, correcting the flow of hydraulic fluid to bring the system back in line with the intended motion. This continuous feedback and correction ensure that the platform moves exactly as required to replicate the vibration conditions being tested.
5. Vibration Controller: Vibration controller 121 takes the vibration measurements of sensors 120 on the hydraulic shake table (UUT 119) and targeted vibration profile generates the drive signal that fed into the servo valve 103. Details of the vibration controller will be discussed in other sections of this document.

In summary, the hydraulic shaker system works through the coordinated action of its components: the HPU 101 and HSM 102 supply the necessary hydraulic pressure, the servo valve 103 precisely controls the fluid flow, the actuator 104 converts hydraulic energy into platform movement, the vibration controller 121 that generates the drive signal and servo controller 106 that operates the servo valves 103, and the sensors 105 and 120 provide real-time feedback to ensure accuracy. Together, these elements enable the system to simulate vibration with high precision, providing valuable data for environmental testing.

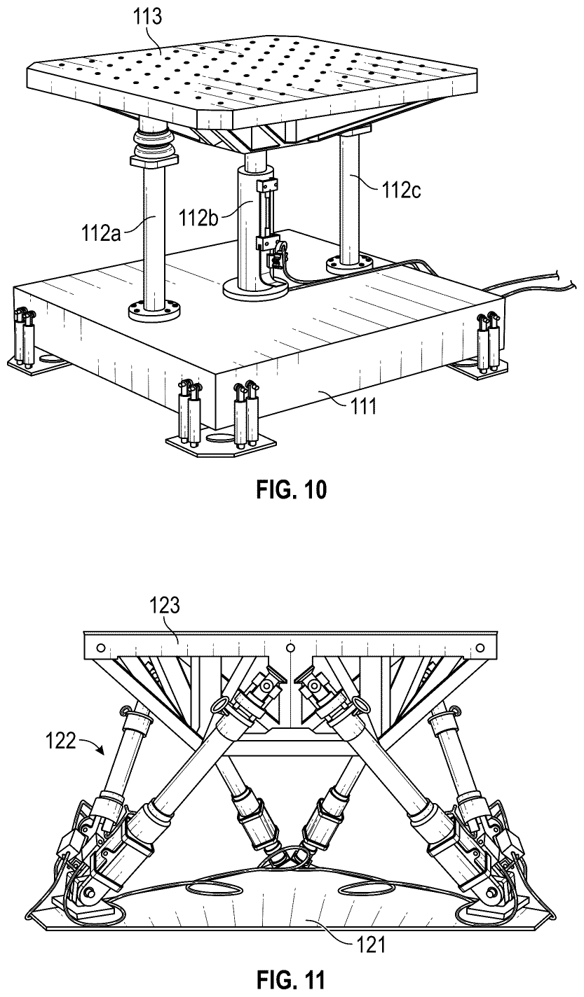

A hydraulic shaker system can have one or multiple actuators 104, i.e., cylinders. In a typical single actuator with vertical axis setup (FIG. 10), two additional vertical pods are supporting structures to make the platform 113 stable. Alternatively, a multi-actuator shaker (FIG. 11) might come with 6 actuators to generate 6 degrees-of-freedom (X,Y,Z translations plus rotational pitch, roll and yaw) movement of the shake table 123. A hybrid shaker in accord with the present invention could, in principle, use either type of hydraulic shaker but will typically need only a single vibration axis, and so the FIG. 10 configuration is usually preferred.

### Using MIMO Control:

With reference again to FIG. 5, the governing equations can be expressed as:

$$[ \begin{matrix}{m}_{1} & 0 \\ 0 & {m}_{2}\end{matrix} ] \ddot{x} ( t ) + [ \begin{matrix}{c}_{1} + {c}_{2} & - {c}_{2} \\ - {c}_{2} & {c}_{2}\end{matrix} ] \dot{x} ( t ) + [ \begin{matrix}{k}_{1} + {k}_{2} & - {k}_{2} \\ - {k}_{2} & {k}_{2}\end{matrix} ] x ( t ) = f ( t )$$

where x(t)=[x1(t), x2(t)]^{T} and f(t)=[f1(t), f2(t)]^{T} denote, respectively, the vector containing the displacements and external forces. While this math model can help us to understand the nature of the hybrid system it is difficult to use a math model in the real-time control because the actual structure is a lot more complex than such 2-DOF system.

Given two drive signals and two sets of input feedback signals, the general control strategy can utilize the known basic principle of Multiple-Input Multiple-Output (MIMO) vibration controllers. A shaker system with the number of drive X equal to m, and number of Control Y equal to n, will follow the system equation,

$${\{ Y \}}_{nx 1} = {[ H ]}_{nxm} {\{ x \}}_{mx 1}$$

The [H]_{n×m} is the system transfer function matrix, which is typically evaluated during the pretest stage. {Y} is the linear spectrum vector of the responses (controls), and {X} is the linear spectrum vector of the drives.

The number of control channels can be the same as the number of drive channels, which is referred to as square control; or they can be different, which is called rectangular control. When the number of controls is larger than the number of drives (shakers), it is over-defined control. The opposite situation is underdefined control. Practically, square control and over defined control are more commonly used compared to the under-defined control.

Adaptive control guarantees rapid equalization and accurate control when non-linear responses occur. This also reduces the time required to achieve full level testing.

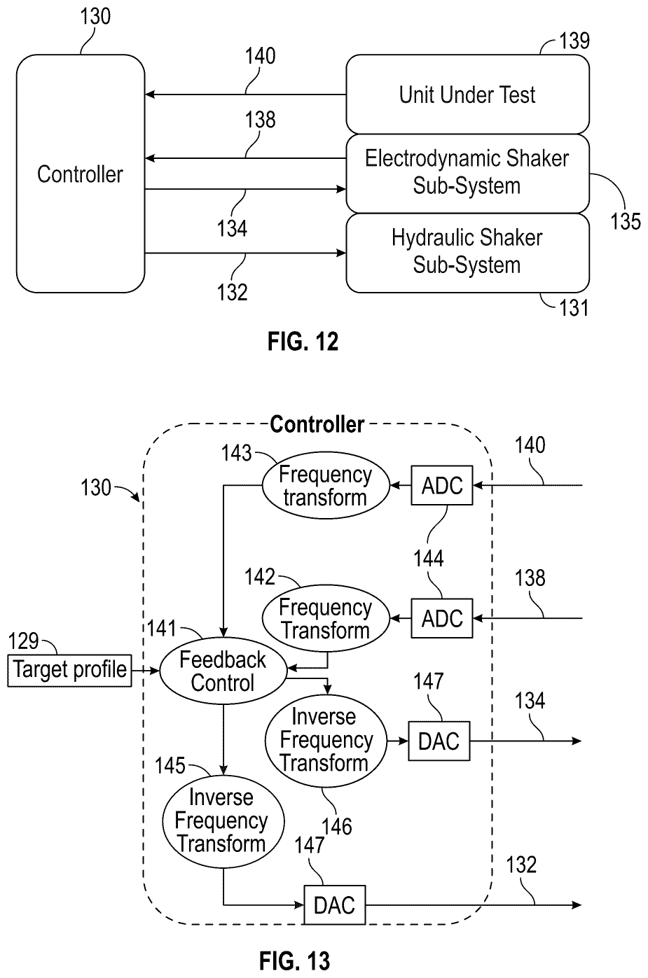

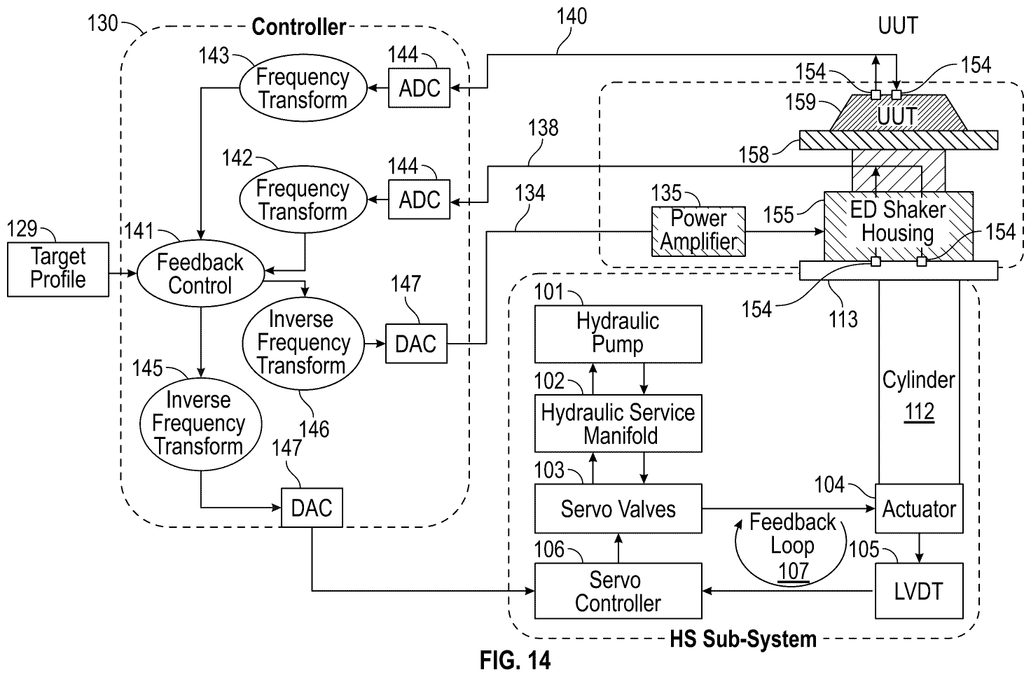

With reference to FIGS. 12 through 14, the control technology we adopt can be called feedback control in the frequency domain. As seen in FIG. 12, the hydraulic shaker sub-system 131 (such as that represented in FIGS. 9-11) shakes an electrodynamic shaker subsystem 135 (such as that represented in FIG. 7-8), which in turn shakes a unit-under-test (UUT) 139. A controller 130 supplies respective drive signals 132 and 134 to the hydraulic and electrodynamic shaker subsystems 131 and 135 and receives in turn sensed vibration feedback control signals 138 from the ED shaker housing (representing the response to the hydraulic component of shaking) and sensed vibration control signals 140 from the UUT 139 (representing the response to the combined shaking of the entire hybrid shaker). The controller 130 is shown in more detail in FIG. 13. In this method, the input time domain signals (e.g., the sensed vibration signals 138 and 140 after being digitized by ADCs 144) are always transformed into frequency domain. The transform can be conducted through either FFT (Fast Fourier Transform), DFT (Discrete Fourier Transform), tracking filter or the like (represented by frequency transforms 142 and 143). Once the signals are in the frequency domain, the measurement vibration signals, either in displacement, velocity, or acceleration, will be compared with their target profile 129 by the feedback control unit 141 to directly generate the drive signals. Alternatively, the drive signals can be generated by multiplying the target signals by an inverse transfer function matrix. Either way, the drive signals in frequency domain will be generated. These frequency spectra of drive signals will be converted to time domain through inverse frequency transform 145 and 146 then output to the digital-to-analog converters (DACs) 147 as analog output 132 and 134 that drive the servo valve in the HS system and the voice coil in the ED shaker (via the power amplifier 135 seen in FIG. 14).

FIG. 14 shows a hybrid vibration test system in its entirety. The piston rods of actuator cylinders 112 of the HS subsystem drive its shaker table 113 to which is mounted the ED shaker housing 155 (as in the configuration of FIG. 4). The ED shaker drives its shaker table 158 upon which the UUT 159 is mounted. Vibration sensors 154 attached to the ED shaker housing 155 and the UUT 159 send the sensed vibration control feedback signals 138 and 140 to the controller 130.

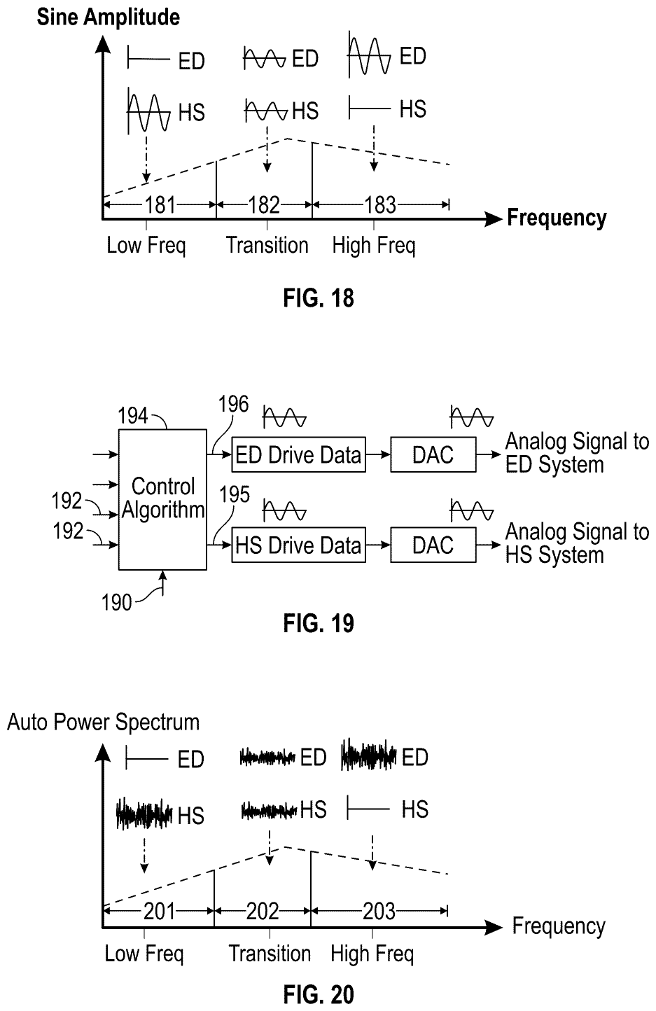

The controller 130 will have prior knowledge about the frequency response of the ED path and HS path. The HS will cover the lower frequency band and ED the high frequency band (as will be discussed below with reference to FIGS. 18 and 20). Very often, ED and HS frequency responses will have overlap in a certain area, called a transition band. Overlapping frequency response means that at this frequency either ED or HS path, or both, can generate the movement to UUT. Based on the prior knowledge of these frequency response functions and other configurations, MIMO control will automatically determine the quantity of the drive signal at any given specific frequency. Here the quantity often is a complex value containing the amplitude and phase. This is the basic principle of control process of the controller applying to such hybrid shaker system.

### Various Testing Types:

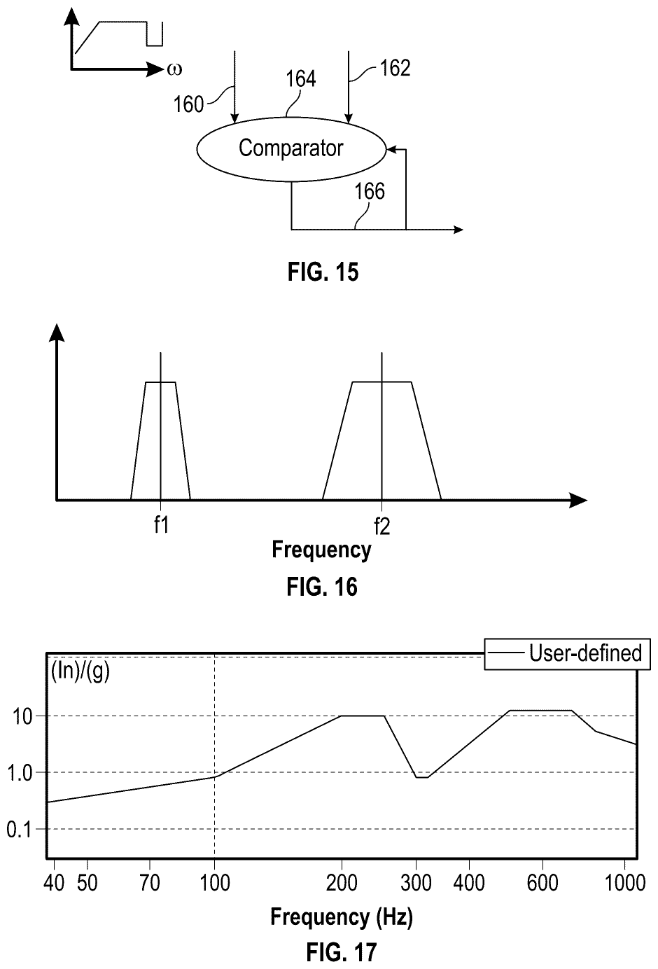

With reference to FIG. 15, as mentioned earlier, the goal of a shaker system is to generate the vibration movement on the Unit Under Test (UUT) that closely matches the targeted reference profile 160. The vibration response 162 on the UUT is fed back to the VCS controller through transducers that measure acceleration, velocity, or displacement. Upon a comparison 164 of the vibration response 162 with the reference profile 160, the controller then adjusts the drive output 166 to ensure that the control signal conforms to the specified characteristics in the time or frequency domain.

There are many types of vibration control tests, including Sine, Multi-Sine, Random, Sine-on-Random, Random-on-Random, Classical Shock, Shock Response Spectrum, Transient Time History, Shock Response Spectrum, and Time Waveform Replication. A sine controller continuously outputs a sinusoidal signal with a varying frequency according to a preset schedule. The amplitude is adjusted to maintain a peak value in the control signal, as specified by the frequency profile. A random controller continuously outputs a wideband, random drive signal so that the control signal exhibits a power spectral density conforming to a given frequency profile. Classical shock controllers define a profile in the time domain, specifying the shape and amplitude of a short-duration pulse. Shock Response Spectrum (SRS) control defines the pulse in the frequency domain. Time Waveform Replication (TWR) controllers define their profiles as long-duration time domain signals, making them suitable for road simulation. Sine-on-Random and Random-on-Random, also known as mixed mode control, combine the random controller with another sine or random controller. This setup is considerably more complex.

Even with a single excitation source, there are reasons to use multiple sensors in different locations as inputs in the control loop. When multiple inputs are used for control, a control strategy is employed to combine the signals, such as averaging, maximizing, or minimizing them. For example, the averaging strategy takes a weighted average of all the control measurement channels.

### Generating Sine Vibration:

Now let's look at how to generate a swept sine vibration with our hybrid vibration test system. The swept sine control process consists of generating a sine wave output to excite the device under test, detecting the control signal input amplitude, comparing the detected level with the reference amplitude, and updating the drive signal amplitude appropriately. To measure the level in the incoming control signal, the detector can use different estimators including tracking filter, or can measure the RMS, peak, or mean value of the signal. When using a tracking filter, amplitude and phase data are produced while the other measurement methods only produce amplitude data. Tracking filters, as in FIG. 16, greatly reduce the noise and harmonic signals above and below the sine drive frequency. Their center frequency is always tuned to the current drive frequency, allowing all other signals to be rejected from measurement and control. The filter bandwidth can be either fixed or proportional to the current frequency.

With reference to FIG. 17, the target vibration will be defined in the frequency domain as a profile spectrum, which is represented by the amplitude of a sine wave at different frequencies.

We understand that that HS system can generate vibration in the low frequency range with benefits of creating very large displacement, while the ED shaker is good at generating vibration at higher frequency range up to a few kilohertz. No doubt that we can design a controller that creates the drive signal if the target vibration is fixed at certain frequency (this is called sine dwelling) and designate that the vibration is generated by one of HS or ED sub-systems. However, during most of the test the sine signal must be swept through a frequency range, say between 0.1 Hz and 2500 Hz. There must be a transition period between the usage of HS and ED sub-system. The transition cannot be an abrupt switch. It must be gradually transited from one mode to another. In other words, at certain frequency the movement of shaker table must be contributed by both HS and ED sub-systems. The plot in FIG. 18 shows the situation. In this diagram, it is seen that in the low frequency range 181, the vibration of shaker table only comes from the drive of HS system while in the high frequency range 183, the vibration comes from that of ED shaker movement when HS does not generate any. During sweep in the transition band 182, the vibration comes from the motion of both ED and HS. To allocate the relative contribution of the ED and HS movements in the transitional band 182, the controller must have the knowledge about characteristics of both HS and ED sub-systems such as their maximum displacement, maximum velocity, maximum acceleration, lowest frequency range, highest frequency range, sensor sensitivity, drive input type and input range, and frequency responses. Many system parameters and testing parameters must be either entered or measured before the actual test. During the test, the CPU (or DSP processor) shall conduct a continuous real-time digital control process. The CPU takes all the testing parameters and system configurations and computes the drive signals for the ED and HS sub-systems simultaneously and continuously.

With reference to FIG. 19, while the data rate sent to the DAC (Digital to Analog Converter) of the drive signal of ED sub-system and HS sub-system can be different, the generated analog drive signals must be in phase and must be synchronized. In other words, the analog drive signals from two paths 195 and 196 cannot deviate their frequency over lengthy period of testing time. This can be achieved by having one mathematical operation 194 that generates the data streams of two types of drive signals during the same control feedback loop. As long as the two data streams 195 and 196 are generated during the same process and the phase shift of each path are calibrated to each other, even if the sampling clocks of DAC on the two paths are different, the final analog signals after the DAC will still be synchronized. If, however, the ED drive data stream and that of HS were to be generated in the separate control process, the phase of sine waves of two drive signals will eventually deviate from each other. Then the control process would break down. Phase shift is equivalent to time delay at certain frequency. The calibration of phase shift between two paths is a complex process. The calibrated result shall be a frequency-dependent function that is to be used to adjust the time delay at each frequency range. Keep in mind that the vibrations generated from ED sub-system and that of HS are not simple relationships of addition. In fact, it is a very complex formula to solve to generate adequate drive signals at certain frequency. This is where the MIMO control algorithm works. One example of a MIMO multi-shaker control taking system and testing parameter inputs 190 and vibration feedback inputs 192 to generate the relative drive outputs 195 and 196 is that described in U.S. Pat. Nos. 4,782,324; 4,937,535; 5,299,459; and 5,517,426.

### Generating Random Vibration:

The second most used testing type is called Random vibration. In a Random test, the shaker is driven by a wide band random signal. Feedback control adjusts the drive signal to generate a response that conforms to a specified testing profile. The control algorithm calculates the inverse transfer function between the output drive and the input control channels, encompassing the amplifier, shaker, and UUT response. The product of the inverse transfer function and the response profile then gives the output drive spectrum. A phase randomizer and inverse FFT then generates the random drive output time stream.

Random excitation is often used to simulate real world vibration. The purpose of the random vibration control system is to generate a true random drive signal such that, when the signal is applied via an amplifier/shaker to the device under test, the resulting shaker output spectrum will match the user-specified test profile. This test profile is defined in the frequency domain in units of (Acceleration)²/Hz. This signal is to be applied to the UUT for a specified amount of time to verify the device's ability to function in its service environment.

If the series of components being controlled, i.e., the amplifier, shaker, and testing structure in the ED path, or hydraulic servo components in the HS path, is assumed to be a linear system, then it can be described by a system transfer function H(f) in frequency domain. The frequency spectra of the control and drive signals, Y(f) and X(f), can be linked together by H(f) as:

$$Y ( f ) = H ( f ) X ( f )$$

$$or$$

$$X ( f ) = {H ( f )}^{- 1} Y ( f )$$

where H(f)⁻¹ is called the inverse transfer function. To apply a specified spectrum to the test article, the drive spectrum must be altered to correct for the dynamics of the shaker/load combination. This process is generally referred to as “Equalization”. The inverse transfer function is calculated continuously while the test is running to monitor any change in the system characteristics. Corrections are applied in real-time.

Given a desired spectrum R(f) (reference spectrum, or profile), the required value for the drive can be calculated as:

$$X ( f ) = {H ( f )}^{- 1} R ( f )$$

where X(f) is the spectrum of the required drive signal. Once the drive spectrum X(f) is known, there are several ways to generate a random drive signal in the time domain. This signal must have the following properties:
A spectral shape defined by X(f)
Follow the level schedule defined by the customer requirements
Free of discontinuities
The signal must be true random instead of pseudo random

The algorithm involves these steps:
1. Digitize the input signals and transform them to the frequency domain using the FFT process.
2. Estimate the inverse system transfer function between the averaged input and output via cross-spectral method.
3. Generate a reference spectrum with random phase.
4. Multiply the reference spectrum by the inverse transfer function and apply an Inverse FFT to the result to generate the output-time waveform, the drive signal.
5. Output the time waveform of the drive signal through a D/A converter.

In the hybrid shaker system, we want the drive signal of ED shaker system to deal with the vibration requirement in the high frequency band while we let the drive of the HS deal with that of low frequency band. The same issue exists of how to deal with the transition band with the two drive signals.

As seen in FIG. 20, the solution is the same that we must run an control algorithm that can generate the data streams of two drive signals simultaneously, based on the frequency band 201, 202, and 203 of the randomize vibration components. The MIMO control algorithm will take the consideration of the testing parameters, testing requirement, system parameters and frequency response functions of ED and HS systems into consideration. The generated analog drive signals will be governed by the this integrated feedback control process. There are similar issues dealing with the phase shift of two paths as in the Sine controller.

The other testing types, such as Sine-on-Random, time waveform replication, Shock or Transient, will all have the same issues addressed above as in Sine or Random, and therefore be dealt with in an analogous manner.

What is claimed is:

1. A hybrid vibration testing system, comprising:
a hydraulic shaker (HS) subsystem responsive to a first HS drive signal to provide a first component of vibration to a hydraulic shaker table;
an electrodynamic (ED) shaker subsystem with a housing that is mechanically coupled to the hydraulic shaker table and responsive to a second ED drive signal to add a second component of vibration onto an ED shaker table configured to support a unit-under-test (UUT); and
a vibration control system, storing a user-specified target vibration profile and receiving real-time sensed vibration input signals as feedback from sensors on both the housing of the ED shaker subsystem and on the UUT, and with at least one processor configured to generate the first HS drive signal and the second ED drive signal such that vibration of the UUT matches the target vibration profile.

2. The system as in claim 1, wherein the HS subsystem includes at least one hydraulic cylinder mounted to a base, each hydraulic cylinder having a piston rod therein that is mounted to the hydraulic shaker table, a hydraulic pump providing pressurized fluid to the at least one hydraulic cylinder and a servo valve directing the pressurized fluid to actuate the piston rod in response to the first HS drive signal such that at least one piston rod vibrates the hydraulic shaker table.

3. The system as in claim 1, wherein the HS subsystem comprises multiple hydraulic cylinder piston rods with respective servo valves and the vibration control system generating a set of HS drive signals, each servo valve and associated cylinder piston rod of the HS subsystem being responsive to a corresponding HS drive signal from the vibration control system to collectively vibrate the hydraulic shaker table.

4. The system as in claim 1, wherein a center of gravity of the ED shaker subsystem coincides with a plane of the hydraulic shaker table.

5. The system as in claim 1, wherein the ED shaker subsystem includes its housing, a shaker body within the housing having a field coil and a voice coil, the voice coil responsive to the second ED drive signal to generate a variable magnetic field, a shaker armature suspended within the shaker body responsive to the magnetic field generated by the voice coil and mechanically coupled to the ED shaker table such that the armature actuates vibration of the shaker table.

6. A system as in claim 5, wherein the ED drive signal is sent through a power amplifier to each voice coil.

7. A system as in claim 1, wherein the ED shaker subsystem comprises multiple actuators and the vibration control system generating a set of ED drive signals, each actuator of the ED shaker subsystem being responsive to a corresponding ED drive signal from the vibration control system to collectively vibrate the ED shaker table.

8. The system as in claim 1, wherein the processor of the vibration control system computes the first HS drive signal and second ED drive signal based on target values defined in a frequency domain with the vibration movement contribution of the HS subsystem tending to be primarily in a low-frequency band, the vibration movement contribution of the ED shaker subsystem tending to be primarily in a high-frequency band, and the vibration movement contributions from both the HS subsystem and ED shaker subsystem in relative proportions dependent upon frequency responses and configuration parameters of the two subsystems in an intermediate frequency transitional band.

9. The system as in claim 1, wherein the vibration control system generates the first and second drive signals in parallel paths from a common feedback control loop to maintain coordination of the respective HS subsystem and ED shaker subsystem vibration movement contributions.

10. A system as in claim 1, wherein the target vibration profile is a pure sinewave of sweeping frequency, and both the first and second drive signals are pure sinewaves, wherein the controller applies tracking filters to the input signals to extract their amplitude and phase as feedback signals.

11. A system as in claim 1, wherein the target vibration profile is a random signal with user-specified spectral shape in the frequency domain, and both the first and second drive signals are random signals, wherein the controller applies Fast Fourier Transforms (FFTs) to the input signals to extract their amplitude and phase as feedback signals.

12. A system as in claim 1, wherein the target vibration profile is a block of transient waveforms in the time domain, and both the first and second drive signals are blocked transient waveform signals, wherein the controller applies FFTs to the blocks of input signals to extract their frequency spectrum as feedback signals.

13. A system as in claim 1, wherein the target vibration profile is a continuous waveform in the time domain, and both the first and second drive signals are continuous waveform signals, wherein the controller applies FFTs to the input signals continuously to extract their frequency spectrum as feedback signals.

14. A hybrid vibration method for use in a system having a hydraulic shaker (HS) subsystem and an electrodynamic (ED) shaker subsystem mechanically coupled in series to vibrate a unit-under-test (UUT), the method controlling the vibration contributions from both subsystems to match a stored user-specified target vibration profile, comprising:
providing a first HS drive signal and a second ED drive signal on parallel paths to respectively drive vibration movement contributions of the HS subsystem and ED shaker subsystem;
receiving real-time sensed vibration input signals as feedback from sensors on both a housing of the ED shaker subsystem and on the UUT;
generating by at least one processor in a common feedback control loop the first HS drive signal and the second ED drive signal, such that vibration of the UUT matches the stored target vibration profile.

15. The method as in claim 14, wherein the processor computes the first HS drive signal and second ED drive signal based on target values defined in a frequency domain with the vibration movement contribution of the HS subsystem tending to be primarily in a low-frequency band, the vibration movement contribution of the ED shaker subsystem tending to be primarily in a high-frequency band, and the vibration movement contributions from both the HS subsystem and ED shaker subsystem in relative proportions dependent upon frequency responses and configuration parameters of the two subsystems in an intermediate frequency transitional band.

16. A method as in claim 14, wherein the target vibration profile is a pure sinewave of sweeping frequency, and both the first and second drive signals are pure sinewaves, wherein the processor applies tracking filters to the input signals to extract their amplitude and phase as feedback signals.

17. A method as in claim 14, wherein the target vibration profile is a random signal with user-specified spectral shape in the frequency domain, and both the first and second drive signals are random signals, wherein the processor applies Fast Fourier Transforms (FFTs) to the input signals to extract their amplitude and phase as feedback signals.

18. A method as in claim 14, wherein the target vibration profile is a block of transient waveforms in the time domain, and both the first and second drive signals are blocked transient waveform signals, wherein the processor applies FFTs to the blocks of input signals to extract their frequency spectrum as feedback signals.

19. A method as in claim 14, wherein the target vibration profile is a continuous waveform in the time domain, and both the first and second drive signals are continuous waveform signals, wherein the processor FFTs to the input signals continuously to extract their frequency spectrum as feedback signals.
